(19) United States
(12) Patent Application Publication
(10) Pub. No.: US 2012/0188149 A1
(43) Pub. Date: Jul. 26, 2012

(54) HEAD MOUNTED DISPLAY

(75) Inventor: Hideaki YAMADA, Oobu-shi (JP)

(73) Assignee: BROTHER KOGYO KABUSHIKI KAISHA, Nagoya-shi (JP)

(21) Appl. No.: 13/428,613

(22) Filed: Mar. 23, 2012

Related U.S. Application Data
(63) Continuation-in-part of application No. PCT/JP2010/066460, filed on Sep. 23, 2010.

(30) Foreign Application Priority Data
Sep. 30, 2009 (JP) 2009-229112

(51) Int. Cl. G09G 5/00

(52) U.S. Cl. 345/8

(57) ABSTRACT

A head mounted display is provided. The head mounted display includes an image display unit which is configured to be mountable to a head of a user and optically guide an image to an eye of the user, a control unit which is connected to the image display unit via a connection cable and configured to control display of the image, and a holding unit which is provided to the control unit and configured to hold the image display unit.

### CROSS-REFERENCE TO RELATED APPLICATION

This is a Continuation-in-Part of International Patent Application No. PCT/JP2010/066460 filed Sep. 23, 2010, which claims the benefit of Japanese Patent Application No. 2009-229112 filed Sep. 30, 2009. The disclosures of the prior applications are hereby incorporated by reference herein in their entireties.

### TECHNICAL FIELD

Aspects of the present invention relate to a head mounted display having an image display unit which optically guides an image to an eye of a user.

### BACKGROUND

There has been known a head mounted display (HMD) which includes an image display unit configured to optically guide an image to an eye of a user and is mounted to a head of the user (for example, refer to JP H6-1211259 A).

Since the head mounted display is mounted to the head, the user can recognize an image even when the user looks toward any direction, so that the head mounted display does not relatively limit movement of the user's body. In particular, if the apparatus is made to be small as a whole to be portable, it is expected that the apparatus would be widely spread.

However, for the portable head mounted display, when the user takes off the image display unit, it is difficult to find out an appropriate place at which the user can put the image display unit, which may cause problems. For example, when the user mounts the image display unit to the head in a moving bus or train and then takes off the image display unit from the head during walking, the user should carry the image display unit with a hand during the walking.

Therefore, even though the head mounted display is made portable, the user may be reluctant to use the head mounted display. The head mounted display is started to be used in fields such as medical service and factory as well as in entertainment fields. However, the above problem could be an obstacle to the spread of the head mounted display.

### SUMMARY

Accordingly, it is an aspect of the present invention to provide a head mounted display capable of holding an image display unit which is taken off from a head of a user.

According to an illustrative embodiment of the present invention, there is provided a head mounted display including an image display unit, a control unit and a holding unit. The image display unit is configured to be mountable to a head of a user and optically guide an image to an eye of the user. The control unit is connected to the image display unit via a connection cable and configured to control display of the image. The holding unit is provided to the control unit and configured to hold the image display unit.

The above head mounted display may further include an accommodation unit which is configured to accommodate the connection cable.

In the above head mounted display, the accommodation unit may include a winding unit which accommodates the connection cable by winding at least a part of the connection cable.

The above head mounted display may further include a first operation switch, and the winding unit may be configured to perform a winding operation of the connection cable in response to an operation to the first operation switch.

In the above head mounted display, the first operation switch may be provided to the image display unit.

The above head mounted display may further include a second operation switch provided to the control unit, and the winding unit may be configured to allow a withdrawing operation of the connection cable wound by the winding unit, in response to an operation to the second operation switch.

The above head mounted display may further include a detection unit which is configured to detect whether the image display unit is held by the holding unit, and the winding unit may be configured to perform a winding operation of the connection cable in response to the detection unit detecting that the image display unit is held by the holding unit.

In the above head mounted display, the winding unit may be configured to send out the wound connection cable in response to the detection unit detecting that a holding state of the image display unit by the holding unit is released.

According to the above configuration, the control unit is provided separately from the image display unit and the control unit is provided with the holding unit which holds the image display unit. Accordingly, the user can hold the image display unit taken out from the head simply with the holding unit by attaching the control unit around a waist and the like, so that there is no difficulty in finding out a place at which the image display unit is put.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 shows an overall configuration of a head mounted display (HMD) according to an illustrative embodiment of the present invention;

FIG. 2 illustrates an electrical configuration of the HMD;

FIG. 3 is a perspective view illustrating a configuration of a holding unit;

FIG. 4 is a sectional view illustrating the configuration of the holding unit;

FIGS. 5A and 5B are sectional views illustrating an operation of the holding unit;

FIG. 6 is a perspective view illustrating a configuration of a dropping detection unit;

FIG. 7 is a sectional view illustrating the configuration of the dropping detection unit;

FIG. 8 is a perspective view illustrating a configuration of a holding unit according to a modified illustrative embodiment;

FIGS. 9A and 9B are side views illustrating the configuration of the holding unit according to the modified illustrative embodiment;

FIG. 10 is a flow chart showing cable winding and withdrawal processing;

FIGS. 11A to 11D illustrate a winding operation by the dropping detection unit;

FIG. 12 is a flowchart showing dropping detection processing by a winding unit; and

FIG. 13 is a flowchart showing winding processing by the winding unit.

### DETAILED DESCRIPTION

Hereinafter, an example of a head mounted display (hereinafter, referred to as ‘HMD’) according to an illustrative embodiment of the present invention will be described with reference to the drawings. In this illustrative embodiment, the HMD is a retina scanning type which two-dimensionally scans image light generated based on image information, projects the same into an eye of a user and scans the image light on a retina. However, the present invention is not limited thereto. For example, an inventive concept can be also applied to an LCD-type HMD.

### 1. Overview of HMD 1

### Configuration of HMD 1

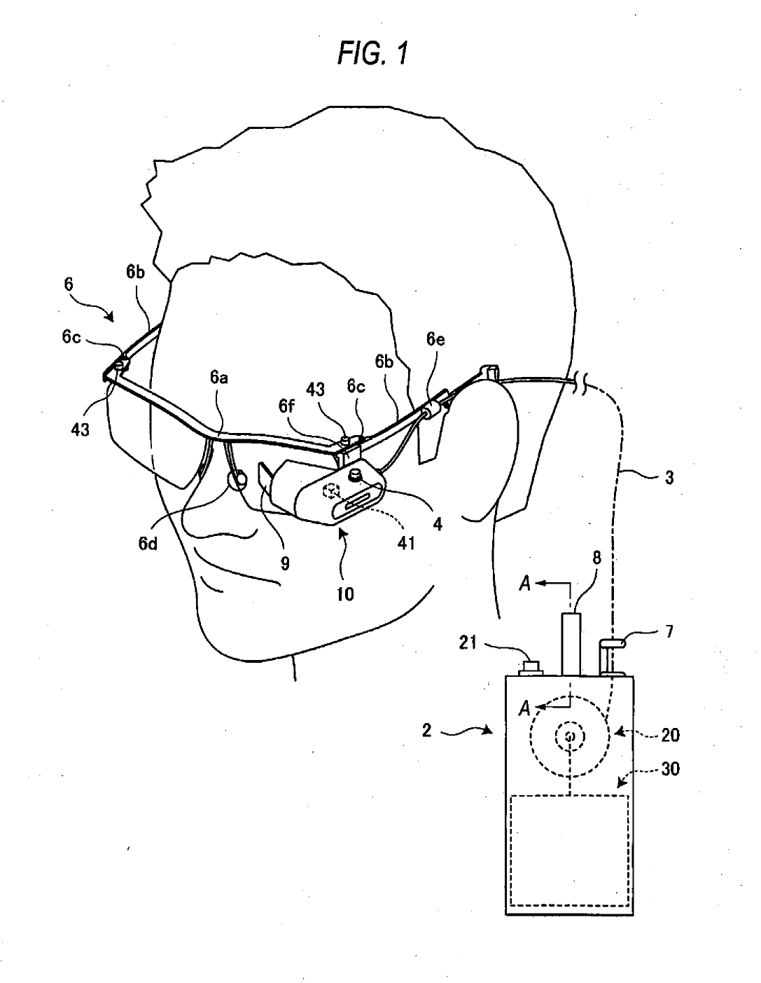

First, an overall configuration of an HMD 1 is described with reference to FIG. 1.

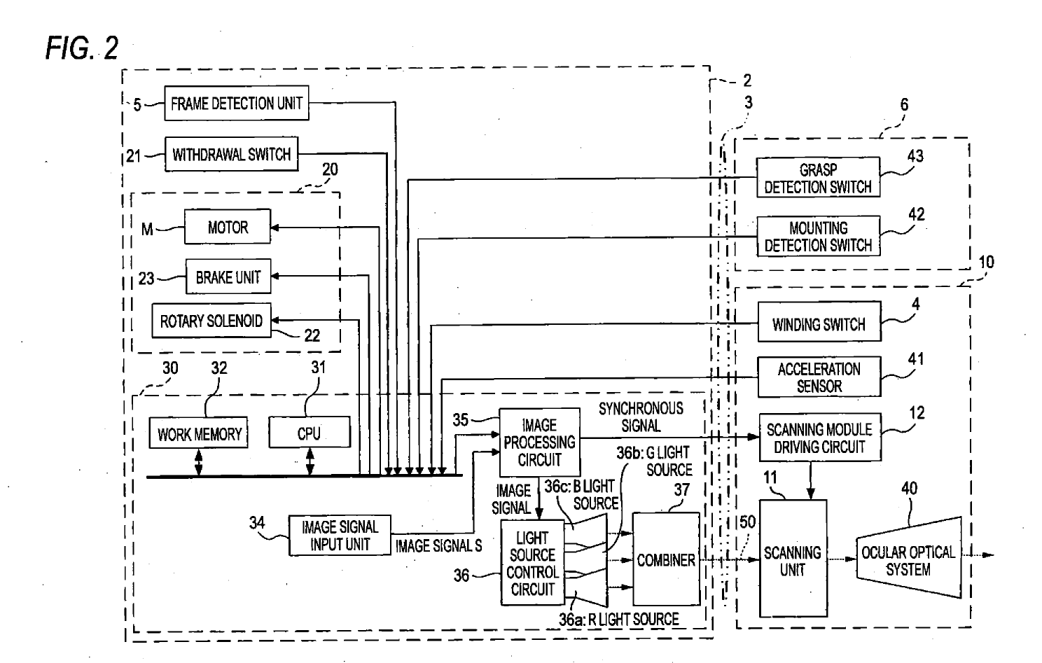

As shown in FIG. 1, the HMD 1 of this illustrative embodiment has an image display unit 3 which is mounted to a head of a user and optically guides an image to an eye of the user, and a control unit 30 which is connected to the image display unit 10 via a connection cable 3 and controls display of the image. The connection cable 3 is formed by covering an optical fiber cable 50 (refer to FIG. 2) and a transmission line for transmitting a synchronous signal (refer to FIG. 2) and the like, which will be described later.

The control unit 30 generates an image signal and emits a light flux having intensity corresponding to the image signal to the optical fiber cable 50 in the connection cable 3, as image light.

The image display unit 10 scans the light flux, which is emitted from the control unit 30 through the optical fiber cable 50 in the connection cable 3, projects the same to the eye of the user and scans the light flux having the intensity corresponding to the image signal on a retina of the eye of the user in a two-dimensional direction, as the image light. The image display unit 10 has a substantial L shape and is provided at a connection part between a left temple 6b and a front 6a, when seen from a user of an eyeglasses-type frame 6, i.e., in the vicinity of a hinge 6c, via a support part 6f. Also, the image display unit 10 is provided with a half mirror 9 via a stay such that the half mirror 9 protrudes to the front of a left eye of the user, and the image light emitted from the image display unit 10 is reflected on the half mirror 9 and is then incident onto the eye of the user.

Since the half mirror 9 is translucent, the half mirror 9 can reflect the image light emitted from the image display unit 10 and allow the same to be incident onto the eye of the user. Also, outside light transmits the half mirror 9 and is then incident onto the eye of the user. Therefore, the user can visually recognize an outside scene by the outside light and an image by the image light at the same time. That is, the HMD 1 is a see-through type HMD which allows the outside light to transmit therethrough and the image light to be projected onto the eye of the user.

### 2. Electrical And Optical Configuration of HMD 1

In the below, electrical and optical configuration of the HMD 1 are described with reference to FIG. 2. The HMD 1 has a structural characteristic in that it includes the image display unit 10 having the control unit 30 and the half mirror 9, the eyeglasses-type frame 6 and the connection cable 3, as described above.

First, electrical and optical configuration of the control unit 30 are described. As shown in FIG. 2, the control unit 30 overall controls operations of the HMD 1. The control unit has a CPU 31 which controls the overall operations of the HMD 1 and a work memory 32 which stores therein a variety of programs for controlling the overall operations of the HMD 1.

The work memory 32 includes a non-volatile flash memory which stores therein the various programs, a RAM which is used as a temporary storage area for executing the various programs, and the like. The CPU 31 reads out and executes the programs stored in the work memory 32, thereby executing image display processing of optically guiding an image to the eye of the user, dropping detection processing of the image display unit 10, winding processing of the connection cable 3 by a winding unit 20, and the like.

The control unit 30 is provided with an image processing circuit 35, a light source control circuit 36, an R light source 36a, a G light source 36b, a B light source 36c and a combiner 37.

The image processing circuit 35 reads out image information from an image signal S, which is supplied from an image signal input unit 34, in a unit of a pixel, and generates image signals for R (red), G (green) and B (blue), based on the read image information of the unit of a pixel.

The light source control circuit 36 generates driving currents for R (red), G (green) and B (blue), based on the respective image signals of the R image signal, the G image signal and the B image signal, which are output from the image processing circuit 35 in the unit of a pixel, and supplies the same to the R light source 36a, the G light source 36b and the B light source 36c.

The R light source 36a, the G light source 36b and the B light source 36c can be configured by semiconductor laser or solid laser having a harmonic generation mechanism, for example. In the meantime, when the semiconductor laser is used, the intensity of the light flux (laser light) may be modulated by directly modulating the driving current. When the solid laser is used, it is necessary to provide an external modulator for each laser and to modulate the intensity of the light flux.

The combiner 37 converges and combines the light fluxes of the respective colors emitted from the R light source 36a, the G light source 36b and the B light source 36c on the same light path, generates image light and allows the image light to be incident onto one end portion of the optical fiber cable 50.

The other end portion of the optical fiber cable 50 is connected to the image display unit 10. The image display unit 10 scans the image light incident from the optical fiber cable 50, allows the image light to be incident onto the eye of the user and scans the image light on the retina of the eye of the user in the two-dimensional direction.

The image display unit 10 has a scanning unit 11, a scanning module driving circuit 12 and the half mirror 9.

The scanning unit 11 collimates the image light incident through the optical fiber cable 50 into parallel light and scans the image light which is made to be parallel light in the two-dimensional direction, i.e., in a main scanning direction and a sub-scanning direction substantially orthogonal to the main scanning direction. The scanning of the image light by the scanning unit 11 is controlled by the scanning module driving circuit 12. The scanning module driving circuit 12 controls the scanning unit 11 such that scanning position of the image light by the scanning unit 11 becomes a scanning position based on a synchronous signal output from the image processing circuit 35.

An ocular optical system 40 has an ocular lens, the half mirror 9 and the like. The ocular optical system 40 allows the image light scanned by the scanning unit 11 to be incident onto the pupil of the user and scanned on the retina of the eye in the two-dimensional direction.

### 3. Configuration of Holding Unit For Image Display Unit And Accommodation Unit of Connection Cable

The HMD 1 configured as described above has a winding unit (an example of an accommodation unit), which winds at least a part of the connection cable 3, and a holding unit which holds the image display unit 10. Thereby, the convenience would be improved when carrying the HMD 1. In the below, configuration of the holding unit and the winding unit are specifically described.

### 3.1. Configuration of Holding Unit For Image Display Unit

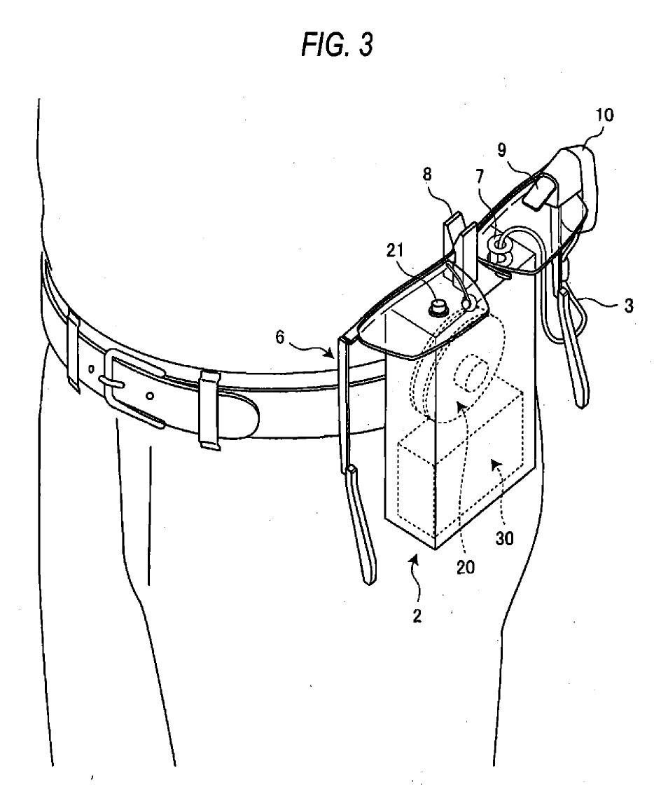

In the below, a configuration of the holding unit in this illustrative embodiment is described with reference to FIGS. 3 to 5A and 5B.

As shown in FIG. 3, the holding unit of this illustrative embodiment is a clip-type stand 8 which is provided to stand upright on an upper surface of an accommodation case 2 having the control unit 30 accommodated therein. The user puts the accommodation case 2 around the waist and holds the image display unit 10 taken off from the head, in the clip-type stand 8. Therefore, the user does not have to carry the image display unit by a hand even during the walking. The holding of the image display unit 10 is made by holding the eyeglasses-type frame 6 supporting the image display unit 10 by the clip-type stand 8.

In the meantime, even when the user does not use the HMD 1 for a while, it is possible to arrange the HMD 1 in a compact manner by holding the eyeglasses-type frame 6 in the clip-type stand 8 provided to the accommodation case 2. Therefore, the HMD does not occupy a storage place and is not an obstacle.

Also, at a state in which the eyeglasses-type frame 6 is held in the clip-type stand 8, the connection cable 3 is wound into the accommodation case 2 by a winding unit 20 (which will be described later), as a length that is not required when holding the eyeglasses-type frame 6. Accordingly, the connection cable 3 is not an obstacle when the HMD 1 is not used, so that it is possible to safely put the HMD 1 temporarily.

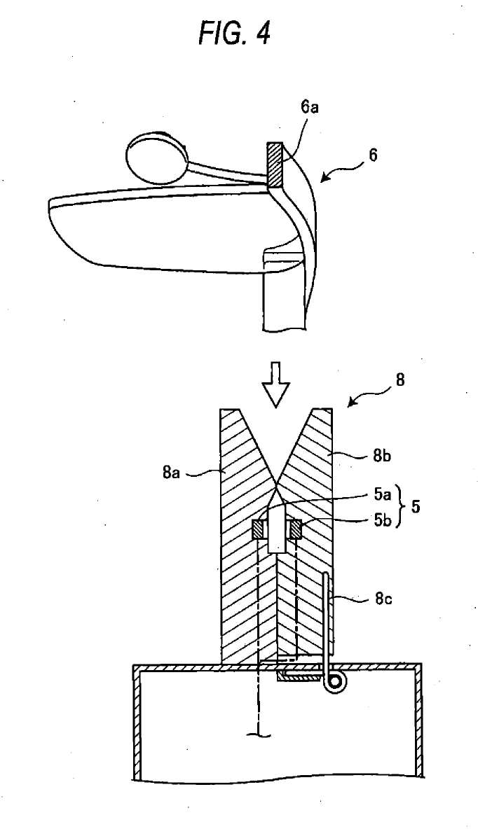

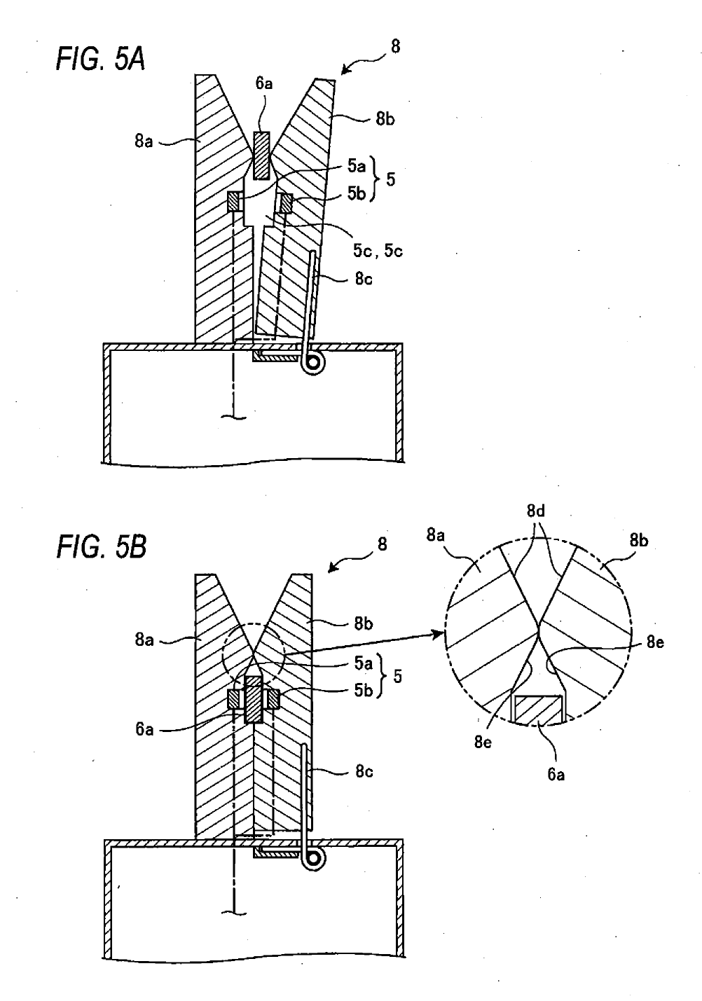

In the below, the configuration and operation of the clip-type stand 8 which is the holding unit are described in more detail with reference to FIGS. 4, 5A and 513. FIGS. 4, 5A and 5B are sectional views taken along a line A-A of the clip-type stand 8 of FIG. 1.

As shown in FIG. 4, the clip-type stand 8 has a configuration in which left and right clip pieces 8a, 8b are opposed to each other and are made to stand upright on the upper surface of the accommodation case 2 of the control unit 30. A base end of one clip piece 8a is fixed on the accommodation case 2. Also, a base end of the other clip piece 8b is connected to one end of a helical spring 8c having the other end fixed to the accommodation case 2. The clip-type stand 8 is configured as described above, so that the eyeglasses-type frame 6 of the image display unit 10 can be held between the left and right clip pieces 8a, 8b by urging force of the helical spring 8c.

Also, as shown in FIG. 5B, upper ends of the left and right clip pieces 8a, 8b have tapers 8d, 8d which are narrowed downwards. Thus, it is possible to insert a central part of the front 6a of the eyeglasses-type frame 6 between the tapers 8d, 8d and to press the same downward against the urging force of the helical spring 8c. The central part of the front 6a pressed as described above is sandwiched by the left and right clip pieces 8a, 8b. Thereby, the eyeglasses-type frame 6 which supports the image display unit 10 is held.

Also, recess portions 5c, 5c are formed below the tapers 8d, 8d and at centers of the left and right clip pieces 8a, 8b such that they are opposed to each other. A frame detection unit 5 which detects the front 6a is provided in the recess portions 5c, 5c. As shown in FIG. 5A, regarding the frame detection unit 5, a photo sensor including a light emitting part 5a and a light receiving part 5b is used. As shown in FIG. 5B, when the front 6a is inserted and pressed between the tapers 8d, 8d and reaches the recess portions 5c, the front 6a is located between the light emitting part 5a and the light receiving part 5b and light emitted from the light emitting part 5a cannot be thus received in the light receiving part 5b. When the light emitted from the light emitting part 5a cannot be received in the light receiving part 5b, the frame detection unit 5 outputs a signal (hereinafter, referred to as ‘holding signal’), which indicates that the image display unit 10 is held by the clip-type stand 8, to the control unit 30.

Also, upper parts of the recess portions 5c, 5c formed at the centers of the left and right clip pieces 8a, 8b have tapers 8e, 8e that which narrowed upward. When the user lifts up the front 6a held between the left and right clip pieces 8a, 8b, the clip piece 8b is expanded against the urging force of the helical spring. Thereby, it is possible to release the holding state of the eyeglasses-type frame 6 by the clip-type stand 8.

That is, according to the HMD 1, the user can arbitrarily attach and detach the image display unit 10 supported to the eyeglasses-type frame 6 to and from the clip-type stand 8 which is the holding unit provided on the upper surface of the accommodation case 2.

### 3.2. Configuration of Accommodation Unit

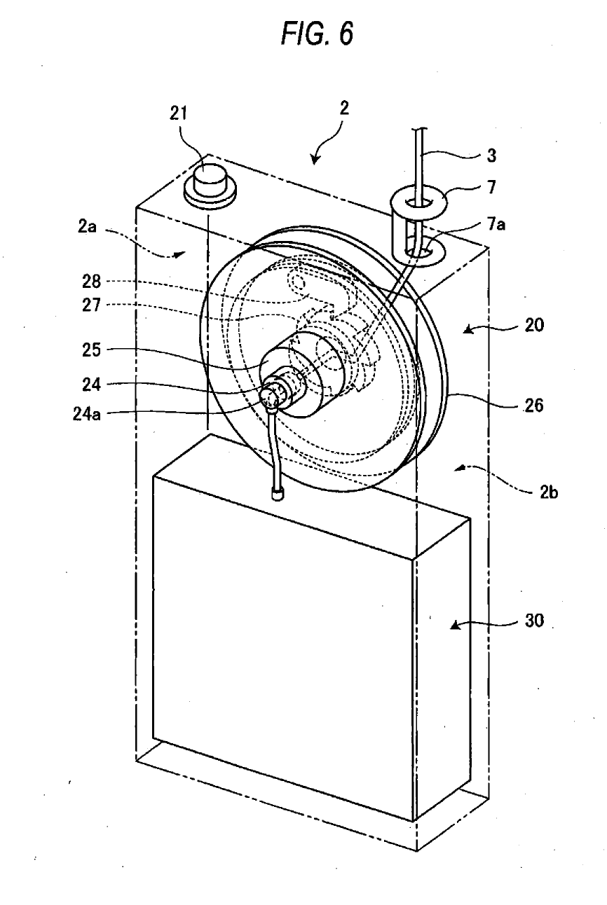

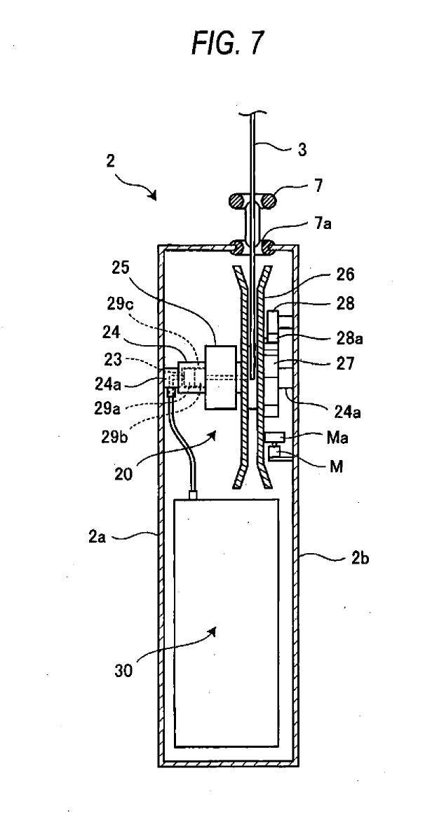

A configuration of the winding unit 20 (an example of the accommodation unit) is described with reference to FIGS. 6 and 7. In the below, the winding unit 20 is described as an example of the accommodation unit. However, the method of accommodating the connection cable 3 is not limited to the winding method and any configuration capable of receiving the connection cable 3 is possible. For example, the connection cable 3 may be folded and accommodated in the accommodation case 2. Alternatively, the connection cable 3 may be pushed in and accommodated at any position in the accommodation case 2.

In this illustrative embodiment, the winding unit 20 is accommodated in an upper half part of the accommodation case 2 having the control unit 30 housed therein, as shown in FIGS. 6 and 7.

A rotary shaft 24 is rotatably and loosely provided on an outer periphery of a support shaft 24a which is provided between a front wall 2a and a rear wall 2b of the accommodation case 2. A helical spring 25, a winding drum 26 and a ratchet gear 27 are integrally connected to an outer periphery of the rotary shaft 24 in order from the front wall 2a of the accommodation case 2 and they are moved as the rotary shaft 24 is rotated.

Also, a tip end claw portion 28a of a winding restraint part 28 which is shaft-supported to the rear wall 2b of the accommodation case 2 is provided above the ratchet gear 27 such that it can be engaged with the ratchet gear 27.

A brake unit 23 is provided between the rotary shaft 24 and the support shaft 24a. The brake unit 23 is configured to stop the rotation of the rotary shaft 24 by an operation instruction from the control unit 30.

The brake unit 23 provided between the rotary shaft 24 and the support shaft 24a has a rubber having high frictional coefficient, which is embedded in the brake unit and can take a contact position at the support shaft 24a. By the operation instruction of an electrical signal from the control unit 30, the brake unit 23 causes the rubber to protrude from the support shaft 24a to an inner periphery of the rotary shaft 24, thereby stopping the rotation of the rotary shaft 24 by friction between the rubber and the rotary shaft 24.

The brake unit 23 is provided to keep a wound state of the connection cable 3 after the connection cable 3 is wound by the winding unit 20.

One end of the helical spring 25 is connected to the rotary shaft 24 and the other end thereof is fixed to the accommodation case 2. As the rotary shaft 24 is rotated, the helical spring 28 is wound or unwound. When the connection cable 3 is withdrawn to the outside of the accommodation case 2, the rotary shaft 24 is rotated and the helical spring 25 is thus wound to accumulate urging force and to urge the connection cable 3 in the accommodating direction. Therefore, when the helical spring 25 is released, the rotary shaft 24 and the winding drum 26 are rotated by the urging force of the helical spring 25 and the connection cable 3 is wound onto the winding drum 26.

Also, the ratchet gear 27 and the winding restraint part 28 provided above the ratchet gear configure a ratchet mechanism. The ratchet mechanism engages the ratchet gear 27 and the tip end claw portion 28a of the winding restraint part 28, thereby limiting the rotating direction of the winding drum 26 to a predetermined direction. Thereby, while the winding drum 26 is allowed to rotate in a direction along which the connection cable 3 is withdrawn to the outside of the accommodation case 2, the winding drum 26 is prohibited from rotating in a direction along which the connection cable 3 is wound into the accommodation case 2.

That is, the winding unit 20 of this illustrative embodiment engages the ratchet gear 27 and the tip end claw portion 28a of the winding restraint part 28 and thus restrains the rotating direction of the winding drum 26 so as to prohibit the winding operation of the connection cable 3 by the urging force of the helical spring 25.

At a normal position of the winding restraint part 28, the ratchet gear 27 and the tip end claw portion 28a of the winding restraint part 28 are located at an engagement position. When a driving signal is transmitted from the control unit 30 to a rotary solenoid 22 connected to the winding restraint part 28, the tip end claw portion 28a is rotated upward. As a result, the engaged state between the ratchet gear 27 and the tip end claw portion 28a is released and the restraint on the rotating direction of the winding drum 26 is released. Also, when the transmission of the driving signal to the rotary solenoid 22 is stopped, the tip end claw portion 28a is returned to its normal position and engaged with the ratchet gear 27, so that the rotating direction of the winding drum 26 is restrained.

That is, the winding drum 26 is allowed to rotate in the direction along which the connection cable 3 is withdrawn to the outside of the accommodation case 2, and when the connection cable 3 is withdrawn to the outside of the accommodation case 2, the rotary shaft 24 is rotated and the helical spring 25 is thus wound to accumulate the urging force and to urge the connection cable 3 in the accommodating direction. When winding the connection cable 3, the winding restraint part 28 is rotated upward to release the engaged state between the ratchet gear 27 and the tip end claw portion 28a of the winding restraint part 28. Thereby, by the urging force of the helical spring 28, the winding drum 26 is rotated in the direction of winding the connection cable 3 into the accommodation case 2 and the winding operation of the connection cable 3 is performed.

When the winding operation of the connection cable 3 by the winding unit 20 ends, the control unit 30 moves the winding restraint part 28 downward, again engages the ratchet gear 27 and the tip end claw portion 28a of the winding restraint part 28 to restrain the rotation of the winding drum 26 and operates the brake unit 23 between the rotary shaft 24 and the support shaft 24a to keep the state in which the rotation of the winding drum 26, which is integrally rotated with the rotary shaft 24, is stopped.

In this illustrative embodiment, the winding unit 20 is provided below the ratchet gear 27 with a motor M for rotating the winding drum 26, as shown in FIG. 7. The motor M has a rotary part Ma at its a tip end, which is brought into contact with a back face of the winding drum 26 at the rear wall 2b of the accommodation case 2. For example, the rotary part Ma is configured by a member having a circumferential surface formed of resin having high frictional coefficient and excellent wear resistance. When the rotary part Ma is rotated, the friction caused between a tip end of the rotary part Ma and the winding drum 26 rotates the winding drum 26 under contact state.

The rotating direction of the winding drum 26 by the motor M is a rotating direction along which the connection cable 3 wound onto the winding drum 26 is sent out to the outside. Also, since the rotating direction of the winding drum 26 is applied with the urging force by the helical spring 25, as described above, a rotary torque of the motor M has to be higher than at least the urging force of the helical spring 25.

In the meantime, the connection cable 3 is provided in the winding unit 20, as shown in FIG. 7. That is, the connection cable 3 is connected from the upper surface of the control unit 30 to a first terminal part 29a in the support shaft 24a via a center of the support shaft 24a provided above the control unit. Also, the connection cable 3 passes through a center of the winding drum 26 from a second terminal part 29b and is connected to the outside of the accommodation case 2 from an upper opening 7a.

The first terminal part 29a is fixed in the support shaft 24a, the second terminal part 29b is fixed in the rotary shaft 24a and the second terminal part 29b is connected to the first terminal part 29a via a connector cover 29c such that the second terminal part can be rotated relative to the first terminal part 26a. The connector cover 29c connects the first terminal part 29a and the second terminal part 29b so that the image light and various signals to be transmitted in the connection cable 3 can be transmitted between the control unit 30 and the image display unit 10 even when the second terminal part 29b is rotated relative to the first terminal part 29a. In the meantime, the optical fiber cable 50 of the image display unit 10 is connected to the optical fiber cable 50 of the control unit 30 such that it can be rotated about an axis of the rotary shaft 24. Also, the first terminal part 29a is formed with terminals each of which transmits a signal and has a ring-shaped recess, and the ring-shaped recesses are concentrically arranged. In the meantime, the second terminal part 29b is formed with terminals each of which transmits a signal and has a convex part, and the convex parts are respectively fitted in the ring-shaped recesses.

### 4. Winding And Withdrawal Operations of Connection Cable

In this illustrative embodiment, as described above, when the user stops or interrupts the using of the HMD 1 or when holding the image display unit 10 taken off from the head in the clip-type stand 8 which is an example of the holding unit, the connection cable 3 connecting the control unit 30 and the image display unit 10 each other can be wound by a length which is not required when holding the eyeglasses-type frame 6.

The winding of the connection able 3 is controlled by the control unit 30. That is, when it is detected that a winding switch 4 (refer to FIG. 1) provided on an upper surface of the image display unit 10 is pressed or when the frame detection unit 5 detects that the eyeglasses-type frame 6 is held in the clip-type stand 8, the control unit 30 performs the winding operation of the connection cable 3.

In order to wind the connection cable 3, the control unit 30 rotates the winding restraint part 28 of the winding unit 20 upward, thereby releasing the engaged state between the ratchet gear 27 and the tip end claw portion 28a of the winding restraint part 28. Thus, by the urging force of the helical spring 25, the winding drum 26 can be rotated in the direction along which the connection cable 3 is wound into the accommodation case 2, and the connection cable 3 is wound as a length which is not required when holding the eyeglasses-type frame 6.

In the meantime, the connection cable 3 can be withdrawn by pressing a withdrawal switch 21 or detaching the eyeglasses-type frame 6 from the clip-type stand 8. Thereby, the user can withdraw the wound connection cable 3 and mount the eyeglasses-type frame 6 to the head.

That is, when the user presses the withdrawal switch 21 provided on the upper surface of the accommodation case 2, the state in which the rotation of the rotary shaft 24 is stopped by the brake unit 23 is released. Thus, the winding drum 26 can be rotated in the direction along which the connection cable 3 is withdrawn to the outside of the accommodation case 2. Therefore, while the user presses the withdrawal switch 21, the user can manually withdraw the connection cable 3 to the outside of the accommodation case 2.

Also, when the frame detection unit 5 detects that the eyeglasses-type frame 6 is detached from the clip-type stand 8, the control unit 30 performs the send-out operation of the connection cable 3, as follows. That is, the control unit 30 first releases the state in which the rotation of the rotary shaft 24 is stopped by the brake unit 23. Then, the control unit 30 drives the motor M to send out the connection cable 3 wound onto the winding drum 26 to the outside of the accommodation case 2.

In the meantime, a cable guide 7 is provided to the opening 7a for the connection cable 3, which is formed on the upper surface of the accommodation case 2. The cable guide 7 is made of a metal material having excellent heat resistance and wear resistance such as titanium (Ti) and is provided so as to smoothly wind the connection cable 23 into the accommodation case 2 and to smoothly withdraw the connection cable 23 to the outside of the accommodation case 2.

### 4.1. Winding And Withdrawal Processing of Connection Cable

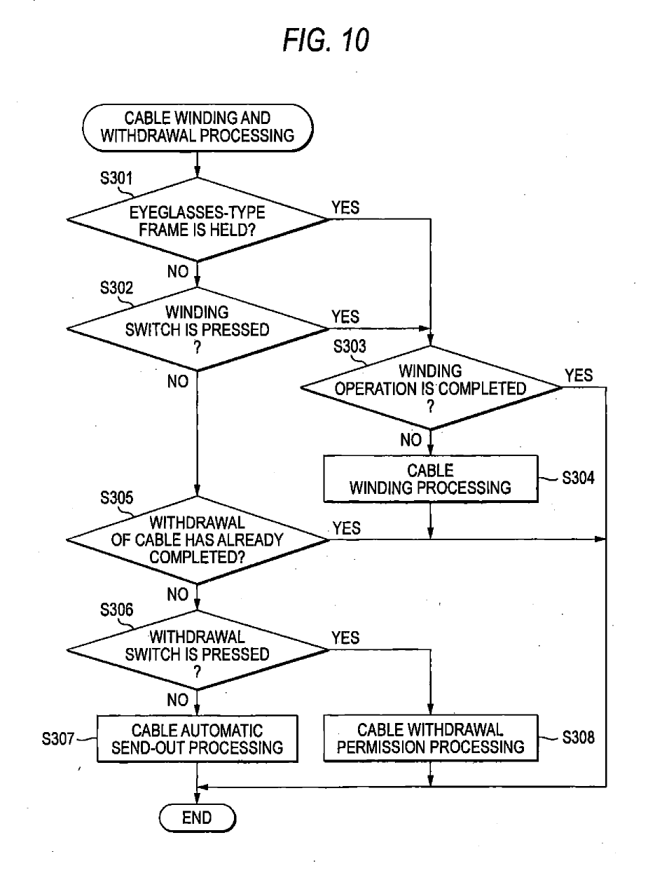

In the below, winding and withdrawal processing of the connection cable, which is performed in the HMD 1 having the above configuration, is described with reference to FIG. 10. The winding and withdrawal processing is performed as the CPU 31 of the control unit 30 reads out the program stored in the work memory 32 of the control unit 30.

First, the CPU 31 of the control unit 30 determines whether the eyeglasses-type frame 6 is held in the clip-type stand 8 provided to the accommodation case 2, based on an output signal from the frame detection unit 5 (step S301). In this processing, when a holding signal is output from the frame detection unit 5, it is determined that the eyeglasses-type frame 6 is held. Then, when it is determined that the eyeglasses-type frame 6 is held (step S301: Yes), the process proceeds to step S303. On the other hand, when it is determined that the eyeglasses-type frame 6 is not held (step S301: No), the process proceeds to step S302.

In step S302, the CPU 31 determines whether the winding switch 4 provided to the image display unit 10 is pressed. In this processing, when it is determined that the winding switch 4 is pressed (step S302: Yes), the process proceeds to step S303. On the other hand, when it is determined that the winding switch 4 is not pressed (step S302: No), the process proceeds to step S305.

In step S303, the CPU 31 determines whether the winding of the connection cable 3 has been already performed by the winding unit 20, i.e., the winding operation is completed. In this processing, when it is determined that the winding operation is completed (step S303: Yes), the CPU 31 ends the winding and withdrawal processing. On the other hand, when it is determined that the winding operation is not completed (step S303: No), the process proceeds to step S304.

In step S304, the CPU 31 performs cable winding processing. In this processing, the CPU 31 outputs a driving signal to the rotary solenoid 22, which is provided to the winding restraint part 28 of the winding unit 20, to drive the rotary solenoid 22, thereby rotating the winding restraint part 28 upward and thus releasing the engaged state between the ratchet gear 27 and the tip end claw portions 28a of the winding restraint part 28. Thereby, by the urging force of the helical spring 25, the winding drum 26 can be rotated in the direction along which the connection cable 3 is wound into the accommodation case 2, and the connection cable 3 is wound as a length that is not required when holding the eyeglasses-type frame 6. Meanwhile, in this cable winding processing, when the operation of winding the connection cable 3 of the predetermined length onto the winding drum 26 of the winding unit 20 ends, the CPU 31 causes the rotary shaft 24 to be unrotatable by the brake unit 23, which is provided between the support shaft 24a and the rotary shaft 24 of the winding unit 20, and keeps the corresponding state. When this processing ends, the CPU 31 ends the winding and withdrawal processing.

In step S305, the CPU 31 determines whether the connection cable 3 of the sufficient length has been already withdrawn from the winding drum 26 of the winding unit 20. In this processing, when it is determined that the connection cable of the sufficient length has been already withdrawn (step S305: Yes), the CPU 31 ends the winding and withdrawal processing. On the other hand, when it is determined that the connection cable of the sufficient length has not been already withdrawn (step S305: No), the process proceeds to step S306.

When the connection cable 3 of the sufficient length, which is necessary to mount the eyeglasses-type frame 6 supporting the image display unit 10 to the head of the user, has been already withdrawn from the winding drum 26 of the winding unit 20, it is possible to suppress the connection cable 3 from being further withdrawn by the processing of step S305.

In step S306, the CPU 31 determines whether an input of the withdrawal switch 21 is detected. In this processing, when it is determined that an input of the withdrawal switch 21 is detected (step S306: Yes), the process proceeds to step S308. On the other hand, when it is determined that an input of the withdrawal switch 21 is not detected (step S306: No), the process proceeds to step S307.

In step S307, the CPU 31 performs automatic send-out processing of the connection cable 3. In this processing, the CPU 31 supplies a driving signal to the motor M of the winding unit 20. Thereby, the winding drum 26 is rotated in the direction along which the connection cable 3 wound onto the winding drum 26 is sent out to the outside of the accommodation case 2, so that the connection cable 3 of the sufficient length, which is necessary to mount the eyeglasses-type frame 6 supporting the image display unit 10 to the head of the user, is automatically sent out (withdrawn). When this processing ends, the CPU 31 ends the winding and withdrawal processing.

Also, in step S308, the CPU 31 allows a withdrawing operation of the connection cable 3. In this processing, when it is determined that the withdrawal switch 21 is pressed by the user, the CPU 31 releases the state in which the rotation of the rotary shaft 24 is stopped by the brake unit 23, so that the winding drum 26 can be rotated in the direction along which the connection cable 3 is withdrawn to the outside of the accommodation case 2. Hence, the user can withdraw the connection cable 3 to the outside of the accommodation case 2. When this processing ends, the CPU 31 ends the winding and withdrawal processing.

As described above, according to the HMD 1 of this illustrative embodiment, when the user stops or interrupts the using of the HMD 1 or when taking off the image display unit 10 from the head, the user presses the winding switch 4 or holds the eyeglasses-type frame 6 in the clip-type stand 8. Thereby, it is possible to wind the connection cable 3 by the winding unit 20, as the length that is not required when holding the eyeglasses-type frame 6.

In the meantime, when the user uses the HMD 1 again, the user presses the withdrawal switch 21 or detaches the eyeglasses-type frame 6 from the clip-type stand 8, thereby withdrawal of the connection cable 3 from the winding unit 20 become possible.

### 5. Modified Illustrative Embodiment of Holding Unit

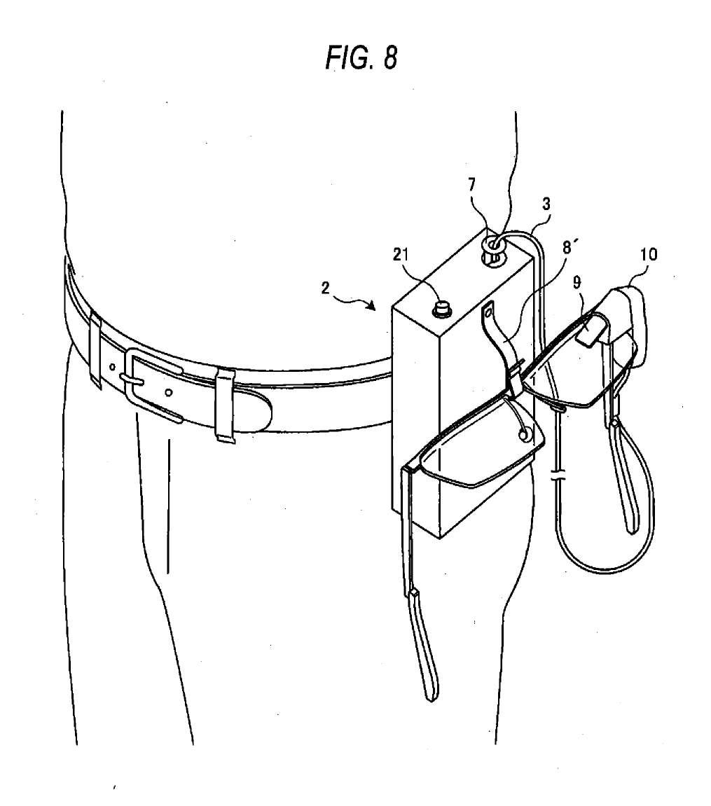

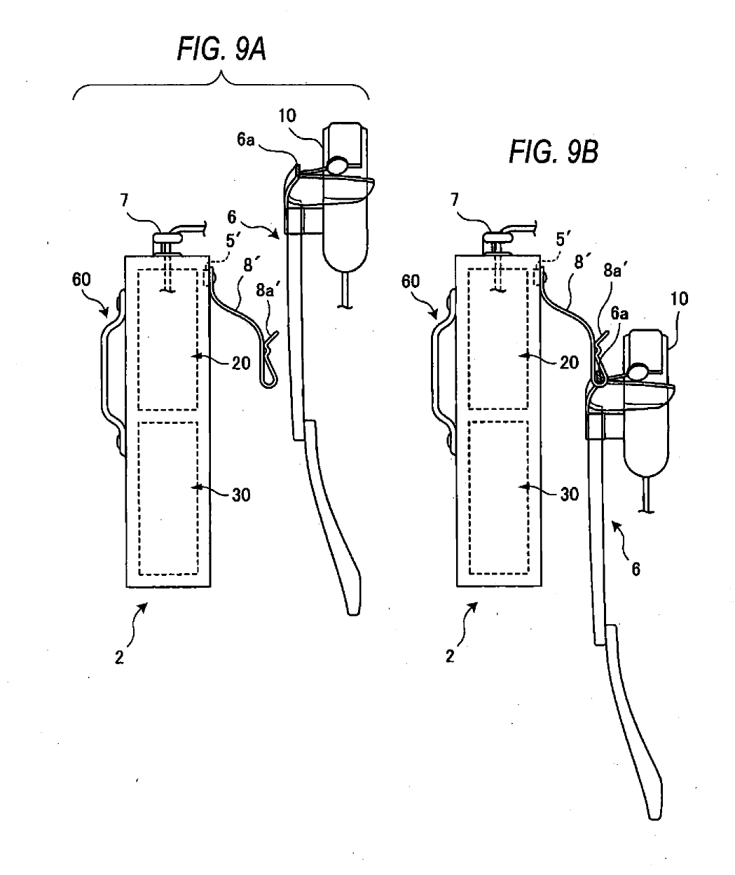

Here, a modified illustrative embodiment of the holding unit is described with reference to FIGS. 8, 9A and 9B. FIGS. 8, 9A and 9B show a configuration of the modified illustrative embodiment of the holding unit. In the below modified illustrative embodiment, the same parts as those of the above illustrative embodiment are indicated with the same reference numerals and the descriptions thereof are omitted, except for different parts from those of the above illustrative embodiment.

As shown in FIG. 8, a holding unit of the modified illustrative embodiment is attached as a hook 8′ on a front face of the accommodation case 2 having the winding unit 20 and the control unit 30 housed therein.

As shown in FIGS. 9A and 9B, the hook 8′ is configured by forming one plate spring having predetermined elasticity into an arm shape. The arm-shaped hook 8′ has a space in which the front 6a of the eyeglasses-type frame 6 is held, and a tip end thereof is provided with an engaging part 8a′ having a folded back shape. The front 6a of the eyeglasses-type frame 6 is detachably mounted to the space holding the front 6a from the engaging part 8a′ of the tip end.

A base end of the hook 8′ mounted on the front face of the accommodation case 2 is provided with a weight sensor serving as a frame detection unit 5′, for example. When the eyeglasses-type frame 6 is held in the hook 8′, the frame detection sensor 5′ detects that the eyeglasses-type frame 6 is held in the hook 8′ based on a change of weight.

In the meantime, instead of the weight sensor as an example of the frame detection unit 5′, the front face of the accommodation case 2 may be provided with a switch (not shown) as an example of the frame detection unit 5′. When the hook 8′ holds the eyeglasses-type frame 6, the hook may be bent to press the switch due to the weight of the eyeglasses-type frame. It may be detected that the eyeglasses-type frame 6 is held in the hook 8′ by detecting that the switch is pressed.

That is, in the modified illustrative embodiment, the holding unit is provided on the front surface of the accommodation case 2. Thus, the user can easily mount and detach the eyeglasses-type frame 6 to and from the hook 8′. Also, the user can easily operate the withdrawal switch 21 provided on the upper surface of the accommodation case 2 even at the state in which the eyeglasses-type frame 6 is held.

Also, as shown in FIGS. 9A and 9B, in the modified illustrative embodiment, the hook 8′ is provided on the front face of the accommodation case 2 and a belt mounting part 60 is provided on a rear face of the accommodation case 2. By binding a user's belt into the belt mounting part 60, the user can carry the accommodation case 2 having the winding unit 20 and the control unit 30 cased therein around the waist.

### 6. Modified Illustrative Embodiment With Dropping Detection Unit

In the below, another modified illustrative embodiment is described. In this modified illustrative embodiment, a dropping detection unit is added which detects that the image display unit 10 is dropped from the head of the user while the user mounts and uses the image display unit 10 to the head of the user. When the dropping detection unit detects that the image display unit 10 is dropped, the winding unit 20 which winds the connection cable 3 into the accommodation case 2 is operated to wind at least a part of the connection cable 3. Thereby, even when the user drops the image display unit 10 by mistake, it is possible to prevent the image display unit 10 from colliding with the floor or ground.

### 6.1. Configuration of Dropping Detection Unit

The dropping detection unit includes an acceleration sensor 41 which detects acceleration of the image display unit 10, a mounting detection switch 42 which detects that the user wears the eyeglasses-type frame 6 and a grasp detection switch 43 which detects that the user grasps the eyeglasses-type frame 6 by a hand.

In the below, the various switch and sensor for detecting that the image display unit 10 is dropped and the switch for detecting that the user grasps the image display unit 10 and the eyeglasses-type frame 6 are described with reference to FIG. 1.

As shown in FIG. 1, two grasp detection switches 43 which detects that the user grasps the eyeglasses-type frame 6 by a hand are provided in the vicinity of the hinges 6c connecting the front 6a of the eyeglasses-type frame 6 and the left and right temples 6b. When it is detected that the grasp detection switches 43 provided to the eyeglasses-type frame 6 are pressed by the user, detection signals are supplied to the control unit 30.

Also, the acceleration sensor 41 is provided in the image display unit 10. When the acceleration sensor 41 detects that the image display unit 10 is displaced with acceleration having a predetermined value or larger, it supplies a detection signal to the control unit 30.

A plurality of the mounting detection switches 42 (not shown in FIG. 1) is provided on surfaces of the left and right temples 6b of the eyeglasses-type frame 6, which are brought into contact with the user from temporal regions to ears, and surfaces of pads 6d provided to the front 6a of the eyeglasses-type frame 6, which are brought into contact with a nose of the user.

When the mounting detection switches 42 detect that the eyeglasses-type frame 6 is mounted to the head (i.e., face), the switches supply detection signals to the control unit 30.

Also, the detection signals of the mounting detection switches 42, the acceleration sensor 41 and the grasp detection switch 43 are supplied from the image display unit 10 to the control unit 30 through the connection cable 3.

### 6.2. Operations of Winding Unit When Image Display Unit Is Dropped In Various Manner

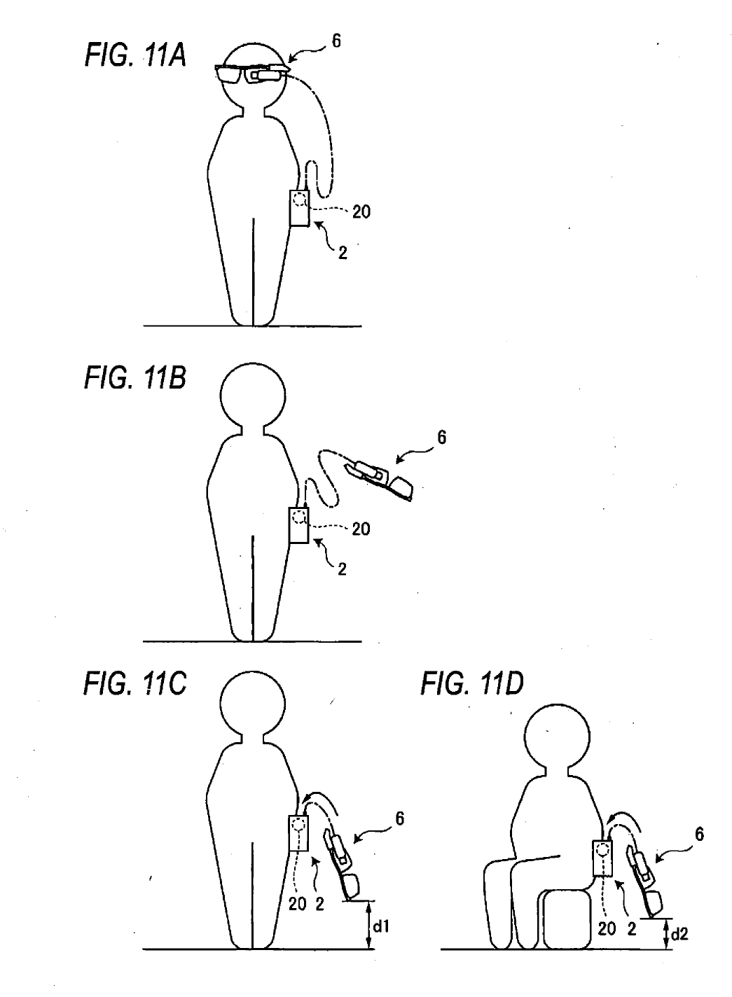

In the below, operations of the winding unit 20, which are made when the image display unit 10 is dropped in various aspects in the modified illustrative embodiment, are described with reference to FIGS. 11A to 11D.

First, as shown in FIG. 11A, when the user uses the HMD 1 of this illustrative embodiment with standing up, the image display unit 10 is mounted to the head of the user with being supported to the eyeglasses-type frame 6. The accommodation case 2 is held at the belt position of the user's waist by a predetermined case cover and the like.

Then, as shown in FIG. 11B, when the control unit 30 detects that the image display unit 10 and the eyeglasses-type frame 6 are separated from the head of the user and are dropped, the winding unit 20 is operated to wind the connection cable 3 of the predetermined length into the accommodation case 2.

Finally, as shown in FIG. 11C, when the image display unit 10 and the eyeglasses-type frame 6 being dropped reach a position of a predetermined distance d1 from a floor surface, the control unit 30 stops the winding operation of the connection cable 3 by the winding unit 20.

Also, for a case where the user uses the HMD 1 of this illustrative embodiment with sitting down on a chair, when the image display unit 10 and the eyeglasses-type frame 6 being dropped reach a position of a predetermined distance d2 from the floor surface, as shown in FIG. 11D, the control unit 30 stops the winding operation of the connection cable 3 by the winding unit 20.

### 6.3. Dropping Detection Processing of Dropping Detection Unit And Winding Processing of Winding Unit

In the below, dropping detection processing is described which detects that the image display unit 10 mounted to the head of the user is dropped. The dropping detection processing starts when the user mounts the image display unit 10 to the head.

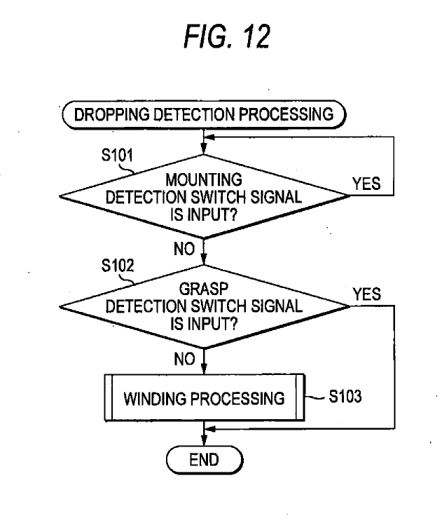

The dropping detection processing is shown in FIG. 12. The CPU 31 determines whether the detection signals from the mounting detection switches 42 are detected or not (step S101). When it is determined that the detection signals from the mounting detection switches 42 are detected (step S101: Yes), the process returns to step S101. When it is determined that the detection signals from the mounting detection switches 42 are not detected (step S101: No), the process proceeds to step S102.

In step S102, the CPU 31 determines whether the detection signal from the grasp detection switch 43 is detected or not When it is determined that the detection signal from the grasp detection switch 43 is detected (step S102: Yes), the CPU 31 ends this dropping detection processing. On the other hand, when it is determined that the detection signal from the grasp detection switch 43 is not detected (step S102: No), the process proceeds to step S103.

In step S103, the CPU 31 performs winding processing in which the winding unit 20 winds the connection cable 3. The winding processing will be specifically described later. When the winding processing ends, the CPU 31 ends this dropping detection processing.

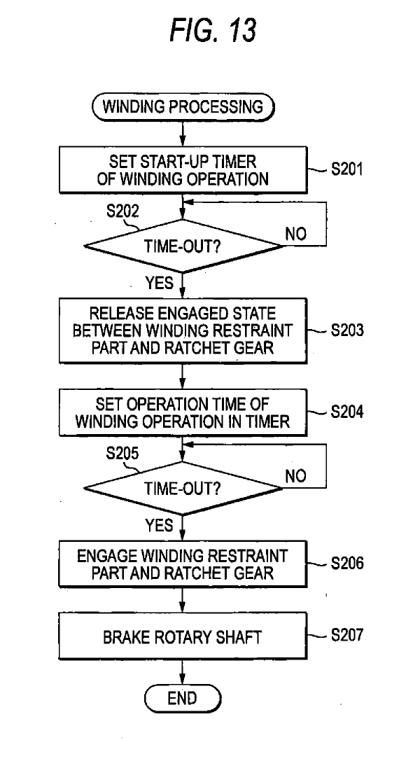

In the below, the winding processing (step S103) which is performed in the dropping detection processing is described with reference to FIG. 13.

In step S201, the CPU 31 sets a start-up timer of the winding operation. Then, in step S202, when it is determined that the timer has not reached a time-out (step S202: No), the CPU 31 suspends the processing until the timer has reached the time-out.

When it is determined in step S202 that the tinier has reached the time-out (step S202: Yes), the CPU 31 rotates the winding restraint part 28 upward to release the engaged state between the ratchet gear 27 and the tip end claw portion 28a of the winding restraint part 28 (step S203).

Then, in step S204, the CPU 31 sets an operation time of the winding operation in the timer.

In step S205, when it is determined that the timer having the operation time of the winding operation set therein has not reached a time-out (step S205: No), the CPU 31 suspends the processing until the timer has reached the time-out.

When the timer having the operation time of the winding operation set therein has reached the time-out (step S205: Yes), the CPU 31 rotates the winding restraint part 28 downward to engage the ratchet gear 27 and the tip end claw portion 28a of the winding restraint part 28, thereby restraining the rotating direction of the winding drum 26 (step S206).

In step S207, the CPU 31 operates the brake unit 23 between the rotary shaft 24 and the support shaft 24a, thereby maintaining the state in which the rotation of the winding drum 26, which is integrally rotated with the rotary shaft 24, is stopped.

Although the winding drum 26 is restrained from rotating in the rotating direction of winding the connection cable 3, it can be rotated in the direction of withdrawing the connection cable 3. Accordingly, for example, the connection cable 3 may be withdrawn due to the own weights of the image display unit 10 and the eyeglasses-type frame 6 supporting the image display unit at the states shown in FIGS. 11C and 11D. However, since the state in which the rotation of the winding drum 26 is stopped is maintained by the processing of step S207, it is possible to prevent the image display unit from contacting the floor or ground.

In the above illustrative embodiment or modified illustrative embodiment, the clip-type stand 8 or hook 8′, which is an example of the holding unit, is provided on the accommodation case 2, and the configuration of winding the connection cable 3 of the extra length into the accommodation case 2 when the image display unit 10 is held in the holding unit is implemented by the relatively simple structure having the helical spring. Accordingly, it is possible to provide the HMD 1 having highly useful function at low cost.

Also, in this illustrative embodiment, the HMD 1 of one-eye type has been described in which the image is projected on one eye of the user. However, the present invention is not limited thereto. For example, the HMD 1 of both-eye type in which images are projected on both eyes of the user may be also provided with the winding unit for the connection cable 3. In this case, two image display units 10 for projecting the images on both eyes and the control unit 30 are preferably configured such that at least a part to be wound of the connection cable 3 is formed by one cable.

Meanwhile, in this illustrative embodiment, the winding unit 20 is provided above the control unit 30 and winds the connection cable 3. However, the present invention is not limited thereto. For example, the winding unit 20 may be provided adjacent to the image display unit 10. Alternatively, the winding unit 20 may be provided at a middle position of the connection cable 3 connecting the image display unit 10 and the control unit 30.

Also, in this illustrative embodiment, the holding unit is provided on the upper surface or front face of the accommodation case 2. However, the provision position of the holding unit is not particularly limited inasmuch as the holding unit can hold the eyeglasses-type frame 6 and is provided to the accommodation case 2 having the control unit 30 and the winding unit 20 housed therein.

Also, in this illustrative embodiment, the connection cable 3 is wound by the urging force of the helical spring 25 and is sent out by the motor M. However, the present invention is not limited thereto. For example, the motor M may be also used to wind the connection cable 3.

Also, in this illustrative embodiment, the clip-type stand 8 or hook 8′ is provided, as an example of the holding unit. However, the holding unit is not limited thereto, and any configuration capable of securely holding the eyeglasses-type frame 6 can be employed.

As described above, according to this illustrative embodiment, following effects can be achieved.

(1) In the head mounted display including the image display unit 10 which is mountable to the head of the user and optically guides the image to the eye of the user and the control unit 30 which is connected to the image display unit 10 via the connection cable 3 and controls the display of the image, the clip-type stand 8 which is provided to the accommodation case 2 having the control unit 30 housed therein and holds the image display unit 10 is provided. Therefore, for example, the user can hold the image display unit 10 taken off from the head by the clip-type stand 8 just by wearing the accommodation case 2 having the control unit 30 housed therein around the waist and the like. Hence, there is no difficulty in finding out a place at which the image display unit 10 is put.

(2) Since the accommodation unit for accommodating the connection cable 3 is provided, it is possible to accommodate the connection cable 3 connecting the image display unit 10 and the control unit 30 by the accommodation unit. Hence, when the image display unit 10 is held by the clip-type stand 8, it is possible to prevent the connection cable 3 from being slack and thus from being an obstacle.

(3) As the accommodation unit, the winding unit 20 is provided which winds at least a part of the connection cable 3 and thus accommodates the connection cable 3. Therefore, for example, it is possible to prevent the connection cable 3 from being accommodated with being bent, so that it is possible to prevent disconnections of various signal lines in the connection cable 3.

(4) The winding switch 4 is provided which allows the winding unit 20 to wind the connection cable 3. Accordingly, for example, the user can wind the connection cable 3, when needed. Hence, it is possible to prevent the connection cable from being wound even though the user does not intend to wind the same.

(5) The winding switch 4 is provided to the image display unit 10. Accordingly, for example, the user can perform the operation of winding the connection cable 3 by one hand while holding the image display unit 10 in the clip-type stand 8. This is particularly convenient when the user can use only one hand.

(6) The withdrawal switch 21 which allows a withdrawing operation of the connection cable 3 wound by the winding unit 20 is provided to the accommodation case 2 having the control unit 30 housed therein. Therefore, for example, the user can easily operate the withdrawal switch 21 at a state in which the image display unit 10 is held by the clip-type stand 8. That is, for a case where the withdrawal switch 21 is provided to the image display unit 10, if the image display unit 10 is held by the clip-type stand 8 with an allowance, the image display unit 10 is moved in pressing the withdrawal switch 21, so that it is difficult to press the withdrawal switch 21. However, the withdrawal switch 21 is provided to the accommodation case 2 having the control unit 30 housed therein, so that it is possible to operate the withdrawal switch 21, irrespective of the holding method of the image display unit 10.

(7) The frame detection unit 5 is provided, which detects whether the image display unit 10 is held by the clip-type stand 8, and the winding unit 20 performs the winding operation of the connection cable 3 when the frame detection unit 5 detects that the image display unit 10 is held by the clip-type stand 8. Therefore, for example, since the connection cable 3 is wound when it is detected that the image display unit 10 is held by the clip-type stand 8, the user does not have to perform the winding operation and is free from the operating of winding the connection cable 3, which improves the convenience.

(8) When the frame detection unit 5 detects that the holding state of the image display unit 10 by the clip-type stand 8 is released, the winding unit 20 sends out the wound connection cable 3. Therefore, for example, since the connection cable 3 is sent out just by detaching the image display unit 10 from the clip-type stand 8, the user is free from the operating of withdrawing the connection cable 3, which improves the convenience.

While the present invention has been shown and described with reference to certain illustrative embodiments thereof, it will be understood by those skilled in the art that various changes in form and details may be made therein without departing from the spirit and scope of the invention as defined by the appended claims.

What is claimed is:

1. A head mounted display comprising:
an image display unit which is configured to be mountable to a head of a user and optically guide an image to an eye of the user;
a control unit which is connected to the image display unit via a connection cable and configured to control display of the image; and
a holding unit which is provided to the control unit and configured to hold the image display unit.

2. The head mounted display according to claim 1, further comprising:
an accommodation unit which is configured to accommodate the connection cable.

3. The head mounted display according to claim 2,
wherein the accommodation unit includes a winding unit which accommodates the connection cable by winding at least a part of the connection cable.

4. The head mounted display according to claim 3, further comprising:
a first operation switch,
wherein the winding unit is configured to perform a winding operation of the connection cable in response to an operation to the first operation switch.

5. The head mounted display according to claim 4,
wherein the first operation switch is provided to the image display unit.

6. The head mounted display according to claim 3, further comprising:
a second operation switch provided to the control unit,
wherein the winding unit is configured to allow a withdrawing operation of the connection cable wound by the winding unit, in response to an operation to the second operation switch.

7. The head mounted display according to claim 3, further comprising:
a detection unit which is configured to detect whether the image display unit is held by the holding unit,
wherein the winding unit is configured to perform a winding operation of the connection cable in response to the detection unit detecting that the image display unit is held by the holding unit.

8. The head mounted display according to claim 7,
wherein the winding unit is configured to send out the wound connection cable in response to the detection unit detecting that a holding state of the image display unit by the holding unit is released.
